(19) United States
(12) Patent Application Publication
(10) Pub. No.: US 2015/0181818 A1
(43) Pub. Date: Jul. 2, 2015

(54) Rainbed Sustainable Raised Bed Garden

(71) Applicant: David Joseph Bonn, St Helens, OR (US)

(72) Inventor: David Joseph Bonn, St Helens, OR (US)

(21) Appl. No.: 14/142,807

(22) Filed: Dec. 28, 2013

(51) Int. Cl. A01G 27/00

(52) U.S. Cl. CPC A01G 27/00

(57) ABSTRACT

The Rainbed is a freestanding, independent structure that harvests, stores and distributes water to irrigate the integrated garden bed throughout one typical 17 week growing season per year. A Rainbed installation requires a level surface and works best in direct sunlight. A Rainbed is comprised of one or two rainwater collector panels, a storage tank, a hand-operated piston pump, and a raised bed garden box. The Rainbed is engineered to store all the water necessary to provide the irrigation needs of the garden bed over a 17 week growing season. The average annual rainfall in most urban locations on the planet is sufficient for achieving sustainability. The Rainbed is engineered to perform in climates with 13 inches or more of annual rainfall.

### BACKGROUND

The inventor has been researching and testing different methods for harvesting, storing and distributing rainwater for the specific purpose of supporting small scale urban-friendly agriculture. The original concept was to construct a freestanding rainwater harvesting shed capable of collecting thousands of gallons of water and distributing the water to adjacent conventional garden plots. This system has high initial cost and offers no innovation to implementing sustainable gardening methods or the efficient use of water.

### BRIEF SUMMARY OF THE INVENTION

The Rainbed is an independent, freestanding wooden structure comprised of a raised bed garden supported over a rainwater storage container and covered by one or two standardized removable rainwater harvester panels. The system is designed to harvest and store enough rainwater to support the garden during the growing season, assuming a 17 week growing season with irrigation of 1″ of water per square foot of garden per week. The harvested rainwater is stored in an enclosed tank space underneath the raised bed garden. The Rainbed is designed to use either a single or a double rainwater harvesting panel, depending on the average annual rainfall. A single collector requires a minimum of 26 inches of annual rainfall for sustainability. A double collector is suited for climates with a minimum of 13 inches of annual rainfall. This relationship applies to Rainbed sizes, Water is extracted from the tank using a hand-operated piston-type pump. Irrigating with 1″ of water per week on a 29 square foot garden requires 2.6 gallons per day, which is pumped into a watering can for application to the garden using the pump installed on a shelf build into the Rainbed.

### BRIEF DESCRIPTION OF THE DRAWINGS

FIG. 1 shows the system schematic for the Rainbed, including the rainwater harvester design, the storage tank design with the range of dimensions, the garden bed design with soil depth and the pump description.

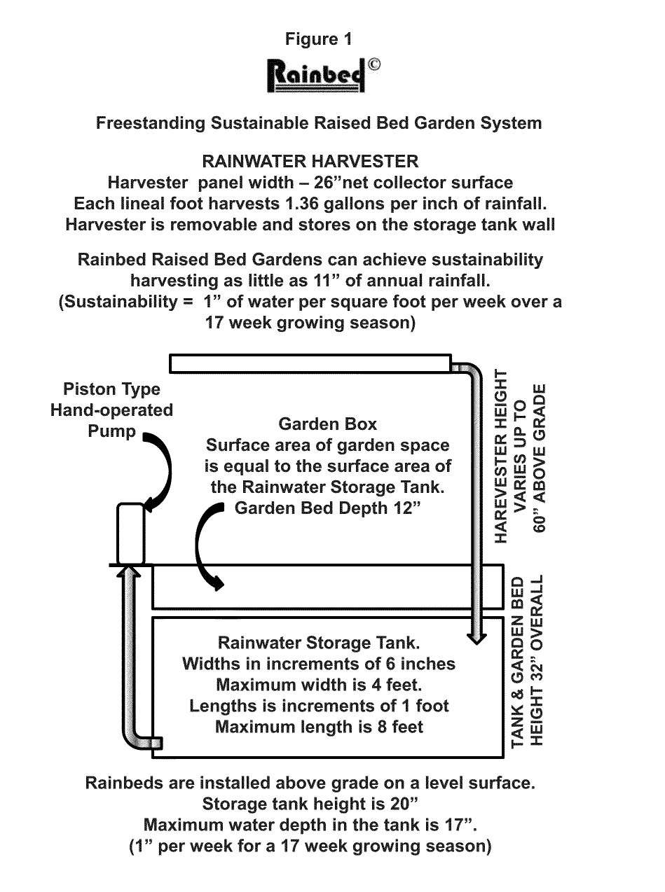

FIG. 2 shows the fully detailed cross sections of the Rainbed, the range of dimensions and the material specifications for each of the components.

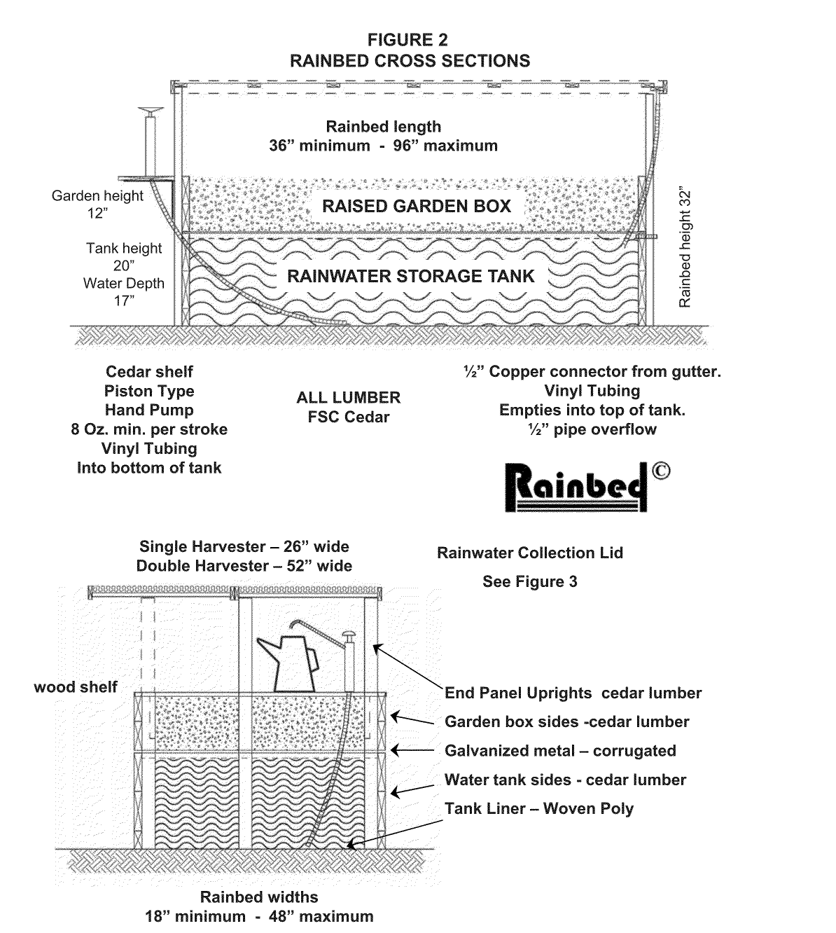

FIG. 3 shows the top view of both the tank lid and the rainwater collector panel. Also shown is a cross section of the gutter and downspout.

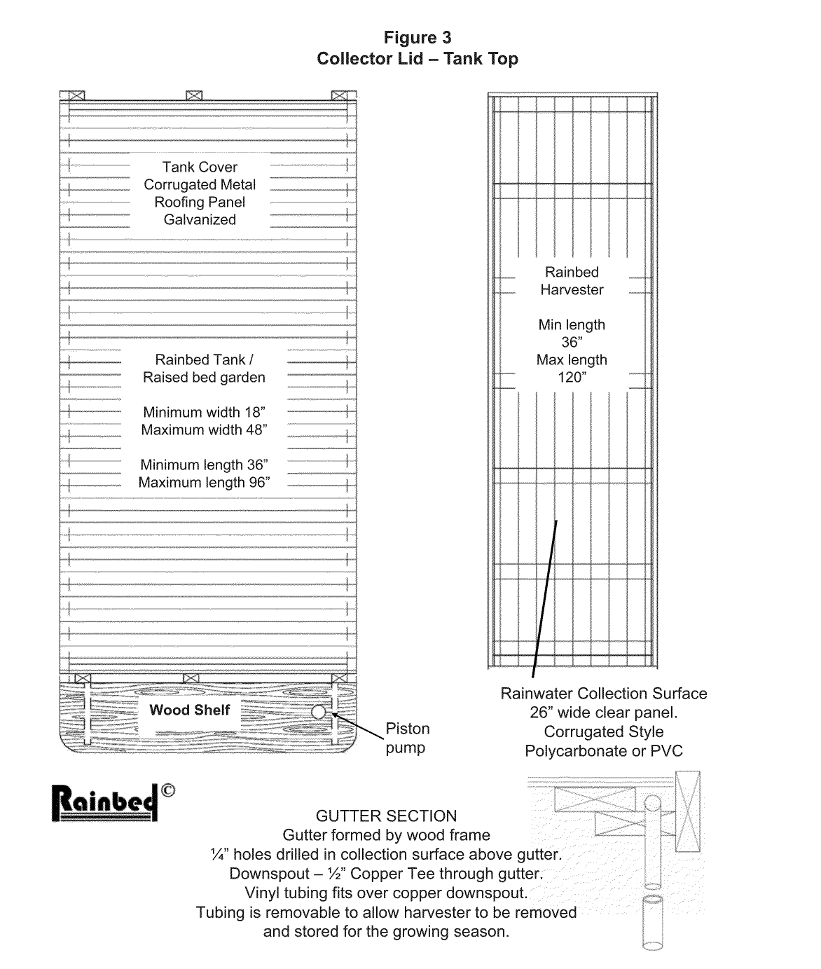

### DETAILED DESCRIPTION AND BEST MODE OF IMPLEMENTATION

The Rainbed is a freestanding wooden structure that harvests, stores and distributes rainwater for irrigating the integrated raised bed garden. Rainbed width range from 18″ to 48″ wide. Rainbed lengths range from 36″ to 96″ long. The tank height, the raised bed garden depth and the overall height from grade level to the top of the garden bed are fixed (overall garden surface height is 32″) for all Rainbeds, regardless of the width and length dimensions. Rainwater harvester heights can vary.

The rainwater harvesting system and the rainwater storage system do not have moving parts. The hand-operated piston-style pump is the only mechanical component in the system. The garden requires 0.63 gallons per square foot per week.

The embodiments of the invention, a compact freestanding, self-sustaining raised bed garden, in which an exclusive property or privilege is claimed are defined as follows:

1. A lightweight, removable rainwater harvesting collector.

2. A water storage container, which is the base of the raised bed garden.

3. A hand-operated water distribution system for drawing water from the tank for use in irrigating the integrated raised bed garden.

4. A raised bed garden box with a fixed surface height of 32″ and soil depth of 12″.

5. The design and engineering of the Rainbed system, which matches average annual rainfall with the harvesting capacity of the collector(s), the storage capacity of the tank, the irrigation needs of the raised bed garden during one annual growing season and the method for drawing the water from the tank for irrigation.
